(19) United States
(12) Patent Application Publication
(10) Pub. No.: US 2026/0340689 A1
(43) Pub. Date: Oct. 29, 2026

(54) SYSTEMS AND METHODS FOR AUTOMATIC ANSWER RATING

(71) Applicant: RELX Inc., New York, NY (US)

(72) Inventors: Shirley Xi, New York, NY (US); Zeek Yu, New York, NY (US); Ryan Lin, New York, NY (US); Samuel Wang, New York, NY (US); Cherlyn Zheng, New York, NY (US); Min Chen, New York, NY (US)

(73) Assignee: RELX Inc., New York, NY (US)

(21) Appl. No.: 19/423,239

(22) Filed: Dec. 17, 2025

Related U.S. Application Data
(60) Provisional application No. 63/790,364, filed on Apr. 17, 2025.

(51) Int. Cl. G06Q 30/0282

(52) U.S. Cl. CPC G06Q 30/0282

(57) ABSTRACT

A method of automatically generating a prompt for a large language model includes receiving a test set comprising a plurality of human ratings and a plurality of large language model ratings. Each human rating of the plurality of human ratings includes a selection of a first product or a second product, and each large language model rating of the plurality of large language model ratings includes a selection of the first product or the second product using the prompt. The method further includes comparing the plurality of human ratings and the plurality of large language model ratings against a metric. When the metric is satisfied, the method includes transmitting the prompt as a final prompt. When the metric is not satisfied, the method includes generating, by an evaluation large language model, a refined prompt.

### CROSS-REFERENCE TO RELATED APPLICATIONS

This application claims priority to U.S. Provisional Patent Application No. 63/790,364 filed on Apr. 17, 2025 and entitled “Systems and Methods for Automatic Answer Rating.”

### BACKGROUND

Artificial intelligence solutions, such as large language models (LLM), are increasingly being incorporated into products. For example, question-answer products receive a question from a user and generate answers based on one or more trained models. However, such answers may have deficiencies, such as due to hallucination and flipping bias. Therefore, products incorporating artificial intelligence should be evaluated across many dimensions, such as accuracy, helpfulness and the like.

Human rating processes are costly, time consuming and produce inconsistent results. Presently there is interest in “LLM as a Judge” systems that leverage large language models as a judge to evaluate the results of two different products to ascertain which product is better. For example, Product A may be a previous or current generation product, while Product B may be a new, updated version of Product A. To ensure that Product B is an improvement, it should be evaluated against Product A. A large language model may be used to determine which results are better across one or more dimensions.

However, LLM as a Judge systems face significant technical challenges in different auto-rating domains, such as the legal domain. A first challenge is cost. It is costly to generate a large sample size to evaluate and rate the different products. In some cases, too large of a sample size may be used, and time and costs could have been saved by using a smaller sample size that would have also been just as effective as the large sample size. Presently there is no guidance as to what is an appropriate sample size for effective evaluation.

Second, rating quality of the LLM as a Judge currently does not currently match that of human rating processes. This may be due to technical challenges of large language models, such as the presence of hallucinations and flipping bias, which is the phenomenon where a large language model produces different results based on the locations of words within the prompt.

Third, it is generally very time consuming to generate prompts for the LLM as a Judge that produce results that are aligned with the results of human rating processes. Significant time is spent changing and updating the prompt to achieve alignment over many, many iterations.

Accordingly, alternative automatic large language model rating systems may be desired.

### BRIEF SUMMARY

In one embodiment, a method of evaluating a first product and a second product, includes testing a first product to generate a first product score for individual samples of an initial sample size in an initial test, testing a second product to generate a second product score for individual samples of the initial sample size in the initial test, determining an increase rate for first product scores and second product scores for the initial test, determining a confidence level for the first product scores and the second product scores for the initial test, where the confidence level is associated with the increase rate based on a mapping table. The method further includes, when the confidence level is less than a threshold, incrementally increasing a size of the initial sample size, determining an increase rate, and determining an updated confidence level until the confidence level is greater than or equal to the threshold. The method also includes, when the confidence level is greater than or equal to the threshold, selecting the initial sample size as the minimum sample size.

In another embodiment, a method of evaluating a large language model includes receiving a test answer from a test product incorporating a test large language model, receiving a control answer from a control product incorporating a control large language model, and receiving, by an evaluation model, a first evaluation request and a second evaluation request, where each includes the test answer and the control answer, and the test answer is provided prior to the control answer. The method also includes receiving, by the evaluation model, a third evaluation request and a second evaluation request, where each includes the control answer and the test answer, and the control answer is provided prior to the test answer. The method also includes outputting, by the evaluation model, for each of the first evaluation request, the second evaluation request, the third evaluation request, and the fourth evaluation request, a test answer selection when the test answer is a preferred answer, a control answer selection when the control answer is the preferred answer, or a tie when neither the test answer nor the control answer is the preferred answer.

In another embodiment, a method of hallucination prevention for a large language model includes, for each sentence of a document generated by a large language model, outputting, by an evaluation model, the sentence as a conclusion/transition sentence or a non-conclusion/non-transition sentence, when the sentence is a non-conclusion/non-transition sentence, outputting, by the evaluation model, the sentence as directly supported by one or more citations or not directly supported by one or more citations, when the sentence is a non-conclusion/non-transition sentence and is not directly supported by one or more citations, outputting, by the evaluation model, the sentence as indirectly supported by one or more citations or non-indirectly supported by one or more citations, and when the sentence is a non-conclusion/non-transition sentence, is not directly supported by one or more citations, and is not indirectly supported by one or more citations, transmitting a hallucination warning to a user.

In another embodiment, a method of automatically generating a prompt for a large language model includes receiving a test set comprising a plurality of human ratings and a plurality of large language model ratings. Each human rating of the plurality of human ratings includes a selection of a first product or a second product, and each large language model rating of the plurality of large language model ratings includes a selection of the first product or the second product using the prompt. The method further includes comparing the plurality of human ratings and the plurality of large language model ratings against a metric. When the metric is satisfied, the method includes transmitting the prompt as a final prompt. When the metric is not satisfied, the method includes generating, by an evaluation large language model, a refined prompt.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an example mapping table according to one or more embodiments described and illustrated herein.

FIG. 1B illustrates an example process for determining a sample size of a product evaluation according to one or more embodiments described and illustrated herein.

FIG. 2A illustrates a chart showing the accuracy for subject matter experts, point-wise rating, pair-wise rating, and robust pair-wise rating according to one or more embodiments described and illustrated herein.

FIG. 2B illustrates a chart showing the consistency for subject matter experts, point-wise rating, pair-wise rating, and robust pair-wise rating according to one or more embodiments described and illustrated herein.

FIG. 3 illustrates an example robust pair-wise rating workflow according to one or more embodiments described and illustrated herein.

FIG. 4 illustrates an example hallucination detection workflow according to one or more embodiments described and illustrated herein.

FIG. 5A illustrates a chart that compares accuracy of sample answer set evaluations performed by human subject-matter experts, the general approach where an LLM is directly asked if a hallucination is present, and the fine-grained hallucination detection method according to one or more embodiments described and illustrated herein.

FIG. 5B illustrates a chart that compares accuracy of sample answer set evaluations performed by human subject-matter experts, the general approach where an LLM is directly asked if a hallucination is present, and the fine-grained hallucination detection method according to one or more embodiments described and illustrated herein.

FIG. 6 illustrates an example workflow for prompt refinement for human-LLM alignment according to one or more embodiments described and illustrated herein.

FIG. 7 illustrates an aspect of the subject matter in accordance with one embodiment.

### DETAILED DESCRIPTION

Embodiments of the present disclosure are directed to large-language model (LLM) auto-rating frameworks that are engineered to assess the answer quality of a question-and-answer system, and particularly a legal question-and-answer system, across various dimensions, including usefulness, relevance, hallucination, fluency, comprehensiveness and more. Embodiments address challenges encountered by existing “LLM as a judge” platforms in the general domain. More particularly, embodiments provide a guideline for a statistically optimized sample test size for rating, an LLM-powered auto-rating framework across multiple dimensions, and an artificial intelligence-human alignment through semi-automated prompting with continuous evolvement process.

To rate or otherwise assess the answer quality of a question-and-answer system, a sample set of many test samples should be run. However, a sample size that is too low may produce unreliable results, while a sample size that is too large may be unnecessarily costly. Presently there is no guidance that allows one to balance sample size for credibility while also controlling costs.

Embodiments of the present disclosure employ a unique method that determines the smallest test sample size that provides a desired reliability. More particularly, embodiments leverage a unique and reliable mapping table that illustrates the correlation between test sample size and the credibility of rating results across a varying quality increase ratio, providing a distinct advantage over existing evaluation frameworks.

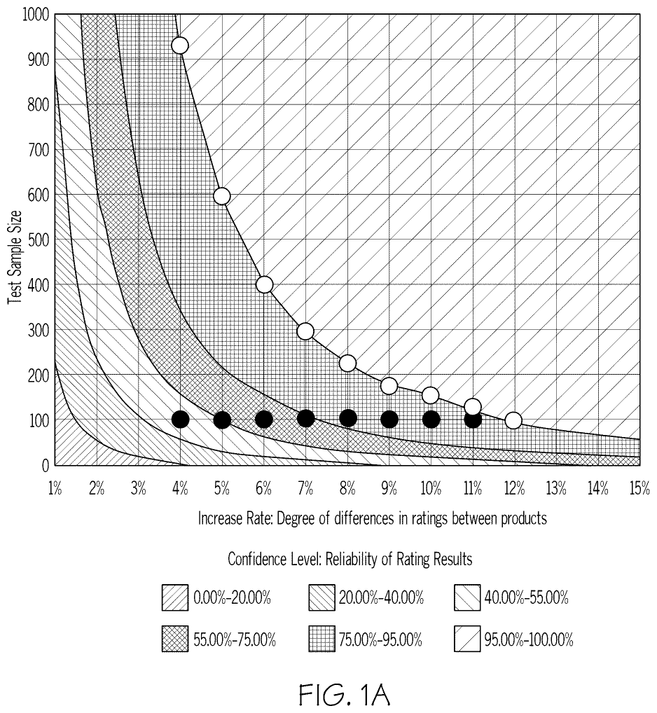

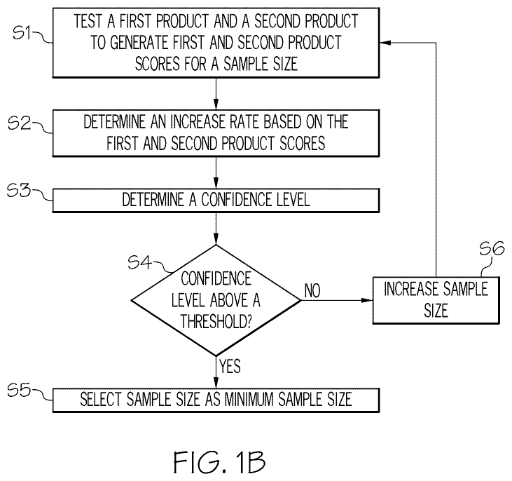

FIG. 1A illustrates an example mapping table that enables users to quickly determine the optimal sample size needed to achieve a specific confidence level when analyzing different LLM products. This ensures that any differences in ratings between various products are statistically significant and not attributable to random chance. Applying this statistical analysis to the overall evaluation framework optimizes the balance between the cost of conducting experiments and the reliability of their results.

The vertical axis is the test sample size, and the horizontal axis is the increase rate of quality between a first product (i.e., Product A) and a second product (i.e., Product B). The test sample size is the number of observations or data points collected for a test. The increase rate is the degree of difference in ratings between products. For example, Product A may be an older version of a question-and-answer product in production, while Product B may be a subsequent, and therefore newer, question-and-answer product under evaluation. Therefore, the horizontal axis represents the percentage of the test results where Product B is better (i.e., more useful) than Product B. For example, if Product B has better results than Product A in 4% of a sample size, it will have a 4% quality increase ratio along the horizontal axis.

The colored regions of the mapping table provide confidence level zones. The dark maroon color includes results having a 0.00%-20.00% confidence level, the maroon color includes results having a 20.00%-40.00% confidence level, and so on. The confidence level is a metric used to determine the reliability of the results. As a non-limiting example, a commonly accepted threshold for statistical significance is a confidence level of 0.95 or higher (which corresponds to a p-value of 0.05 or lower).

The confidence levels are calculated using a t-test, which is a statistical hypothesis test used to determine whether there is a significant difference between the means of two groups. Embodiments of the present disclosure compare the answer quality of the same sets of queries across different products (e.g., Product A and Product B). Embodiments use an independent t-test as a substitute for a paired t-test because embodiments focus on the mean rating difference between the two groups, and plan to generate a mapping table based on historical rating data for future experiments, which precludes obtaining specific rating differences for each sample pair in advance.

The independent samples t-test is as follows:

$${t}^{′} = \frac{{\overline{X}}_{1} - {\overline{X}}_{2}}{\sqrt{\frac{{S}_{1}^{2}}{{n}_{1}} + \frac{{S}_{2}^{2}}{{n}_{2}}}}$$

where:
   X₁ and X₂ are the mean rating results of two different groups;
   S₁ and S₂ are the standard deviation of the rating results;
   n₁ and n₂ are the sample sizes of the two different groups; and
   t′ is the t statistic.

Having computed the t-statistic, the corresponding p-value is ascertained by consulting the t-distribution tables. The confidence level used by the mapping table, which represents the reliability of rating results, is determined by 1 minus p-value.

A p-value of ≤0.05 is a commonly used criterion for determining whether an observed difference is “statistically significant” or not. Consequently, a confidence level exceeding 0.95 is regarded as indicating a “high confidence.” A low confidence (e.g., <55%) indicates the rating conclusion is likely due to random chance. A moderate confidence (e.g., 55%-95%) means the rating results are reasonably reliable but not fully guaranteed. A high confidence (e.g., >95%) means the rating results are statistically significant. Often in studies a confidence level of 80% is agreed upon, corresponding with a p-value of approximately 0.2.

The mapping table of FIG. 1A illustrates the correlation between test sample size and the credibility of rating results across varying quality increase ratios. The mapping table is used to select the minimum sample size that yields a threshold confidence level. In other words, the mapping table is used to select the minimum test sample size for ensuring the reliability of comparative rating results, which in turn reduces costs. Computing resources and time are saved by selecting the smallest sample size, which prevents the use of unnecessarily large sample sizes.

FIG. 1B illustrates a flowchart of a process for using the mapping table of FIG. 1A. At block S1, a first product and a second product are tested to generate first product scores and second product scores for an initial sample size, such as 100. Then at block S2, the process determines an initially observed increase ratio for the sample size, which may be 4%, for example. At block S3, a confidence level for the initial sample is determined by referencing the mapping table, such as the mapping table illustrated by FIG. 1A. Referring to the mapping table of FIG. 1A, an increase ratio of 4% yields confidence level between 40% and 55%.

At block S3, the confidence level is compared to a threshold. As a non-limiting example, the threshold for the confidence level may be 95%. When the confidence level is below the threshold, such as the case of a confidence level between 40% and 55%, the process moves to block S6, where the sample size is incrementally increased. As a non-limiting example, the sample size may be increased by 100. The process then moves back to block S1, where blocks S1-S4 are repeated until an increased sample size yields a confidence level that is greater than or equal to the threshold. For example, after several iterations, a sample size of 400 may produce an increase ratio of 6%, which, according to the mapping table of FIG. 1A, yields a confidence level of at least 95%.

When the confidence level is above the threshold, the sample size is selected as the minimum sample size at block S5, which is the minimum sample size to ensure the reliability of comparative rating results.

Embodiments also employ robust pair-wise rating to achieve a 25% increase in rating accuracy compared with generic point-wise rating, while also providing high stability to eliminate flipping noise and position bias. A point-wise rating simply rates a single answer as being a good answer or a bad answer. On the other hand, a pair-wise rating evaluates two answers, which, in the present application may be a comparison between an answer generated by a first product (e.g., Product A) and a second product (Product B). The pair-wise rating selects which of the two provides the better answer. However, the point-wise rating process struggles with low rating accuracy, mainly because large language models (LLMs) find it challenging to make precise ratings that discern subtle differences within lengthy and complex text passages. This often results in the same overall rating score, overlooking the difference in the nuances of the context. Meanwhile, the pair-wise rating process suffers from low rating stability, potentially resulting from flipping noise and position bias in the large-language model used to generate the answers.

Embodiments of the present disclosure employ a unique robust pair-wise rating process to increase stability and accuracy. A traditional point-wise rating method individually rates an answer as complete or not complete. However, point-wise rating has low accuracy.

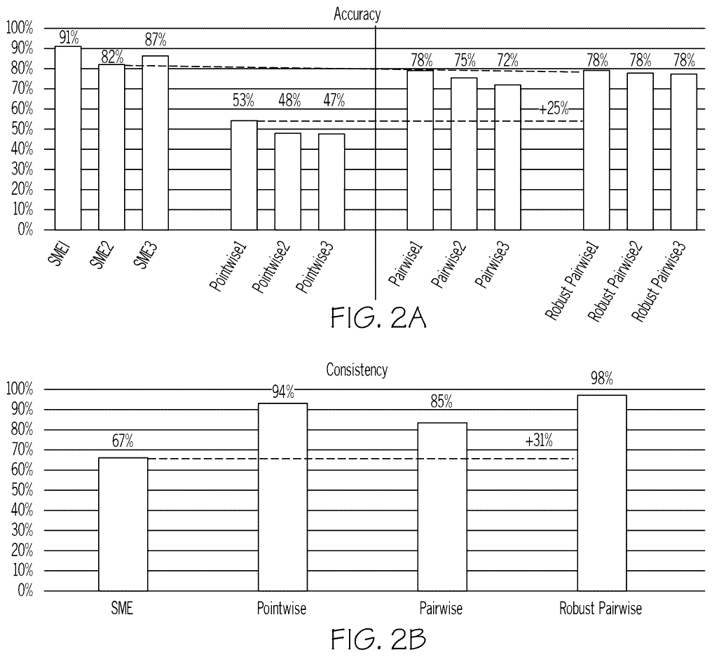

FIG. 2A illustrates the accuracy for subject matter experts, point-wise rating, pair-wise rating, and robust pair-wise rating according to embodiments of the present disclosure. FIG. 2B illustrates the consistency for the subject matter experts, the point-wise rating, the pair-wise rating, and the robust pair-wise rating.

Referring to FIG. 2A, for the SME rating, three human subject-matter experts (SME1, SME2, and SME3) independently evaluated the entire answer set for comparison purposes. For the point-wise rating, the sample answer set was rated three times using a point-wise method. Each time, the accuracy of the sample answer set rated by the point-wise method was less than 54%, which is unsuitable for most applications.

In the pair-wise rating method, answers are evaluated in pairs. For each answer pair, it is determined which answer is more comprehensive. Although the pair-wise rating method has increased accuracy of the point-wise rating method, it suffers from stability issues. Referring once again to FIG. 2A, the sample answer set was rated multiple times by a pair-wise rating method. The accuracy of the pair-wise rating method is significantly greater than that of the point-wise rating method.

However, as shown in the chart of FIG. 2B, the consistency of the pair-wise rating method is almost 10% less than that of the point-wise rating method. Accordingly, both rating point-wise and pair-wise rating methods have undesirable attributes that affect the performance of LLM-based auto-rating.

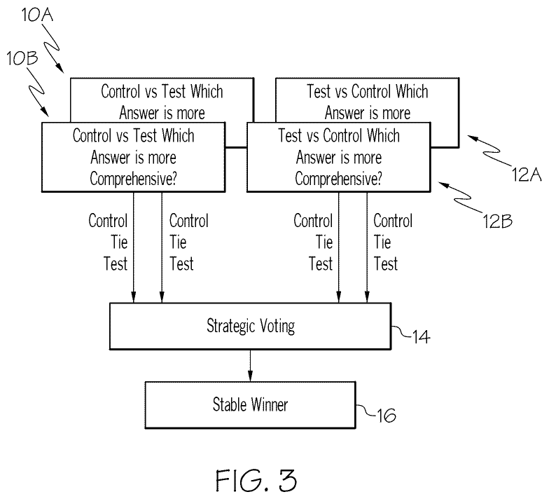

Referring to FIG. 3, embodiments of the present disclosure include a robust pair-wise rating that provides both high accuracy and high stability/consistency. In this method, four total queries are provided to a rating LLM model. A first query 10A asks the rating LLM model “Which answer is more comprehensive, the control answer or the test answer?” As an example, the control answer may have been generated from a previous product, and the test answer may have been generated from a new product, or an updated version of the previous product. The second query 10B asked of the rating LLM model is the same as the first. The third and fourth queries 12A, 12B switch the position of the control answer and the test answer of the first query 10A and the second query 10B by asking “Which answer is more comprehensive, the test answer or the control answer?” The switching of the position of the control answer and the test answer is designed to address the issue of position bias of the rating LLM model.

The outputs of the four queries are then provided to a strategic voting block 14. The outputs (i.e., the answer provided by the rating LLM model as to which answer is more comprehensive) may be control (the control answer is the more comprehensive answer), tie (neither the control answer nor the test answer is more comprehensive than the other), or test (the test answer is the more comprehensive answer). The strategic voting block 14 receives the “votes” in the form of the output and selects control, test or tie as the most relevant answer and the stable winner 16. As a non-limiting answer, where control has two votes, test has one vote, and tie has one vote, then the control answer is selected as the most relevant (i.e., the stable winner 16). If both control and test receive the same amount of votes, the strategic voting block outputs a tie as the stable winner 16.

Referring once again to FIG. 2A and FIG. 2B, the robust pair-wise rating method of the present disclosure has both high accuracy and high consistency. The robust pair-wise rating method has a 31% increase in consistency of human subject-matter expert ratings. The inherent nature of LLMs introduces issues like flipping noise and preference bias, impacting rating stability. Without being bound by theory, asking the rating LLM model the same query twice addresses flipping noise, where LLM models may generate two different answers under the same repeated query. Additionally, switching the position of the control answer and the test answer in the queries addresses position bias, where changing the position of characters in a query may lead to change in answers of LLM models. The robust pair-wise rating method can be used to decide whether a new version or product performs better than an old version or product, for example.

Embodiments of the present disclosure also address low accuracy by fine-grained hallucination detection. The fine-grained hallucination detection surpasses conventional LLM evaluations by dissecting answers into fine-grained components and assessing the substantiation of each component with ground truth citations. The general solution asks the LLM itself whether or not the answer involves a hallucination. However, the LLM may itself involve hallucinations in its answer to the question of whether the answer involves hallucination. Additionally, a long answer may as a whole not have hallucinations, but minor parts of the answer may in fact involve hallucinations.

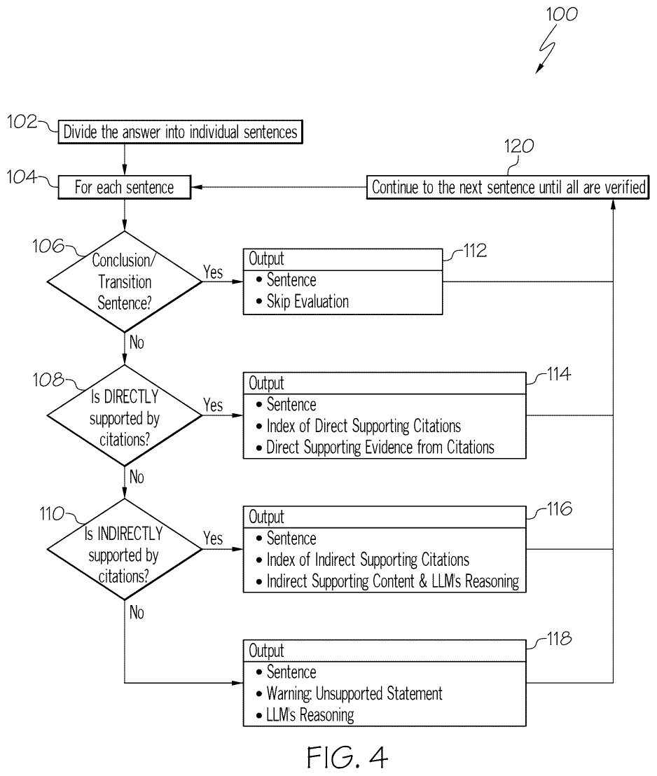

A flowchart 100 of an example fine-grained hallucination detection method is provided in FIG. 4. At block 102, the answer is divided into individual sentences. At block 104 a sentence is considered for evaluation. At block 106 an LLM determines whether or not the sentence under evaluation is a conclusion or transition sentence. If yes, the process moves to block 112. At block 112 the sentence is skipped and the process moves to block 120 where it is determined whether or not there are more sentences to evaluate. If there are more sentences, the next sentence is evaluated starting at block 104.

If the LLM indicates that the sentence under evaluation is not a conclusion or transition sentence at block 106 (i.e., a non-conclusion/non-transition sentence), the process moves to block 108. At block 108 the LLM is asked whether or not the sentence under evaluation is directly supported by citations. If yes, the process moves to block 114 where the LLM outputs the sentence, an index of direct supporting citations, and direct supporting evidence from the citations. The process then moves to block 120 and then to block 104 if there are more sentences to evaluate.

If the LLM indicates that the sentence under evaluation is not directly supported by citations, the process moves to block 110. At block 110 the LLM is asked whether or not the sentence under evaluation is indirectly supported by citations. If yes, the process moves to block 116 where the LLM outputs the sentence, an index of indirectly supporting citations, and indirectly supporting content and the LLM's reasoning as to why it believes these are indirectly supporting citations. The process then moves to block 120 and then to block 104 if there are more sentences to evaluate.

If the LLM indicates that the sentence under evaluation is not indirectly supported by citations, the process moves to block 118. At block 118 the LLM outputs the sentence, a warning regarding unsupported statement, and the LLM's reasoning as to why it believes that the sentence is unsupported. The process then moves to block 120 and then to block 104 if there are more sentences to evaluate.

The steps of FIG. 4 may be performed by a single prompt provided to the LLM in some embodiments. The input for the prompt is the original answer together with supporting content, and the output for the prompt is the LLM's judgement (“skip”/“direct”/“indirect”/“unsupported”) for each sentence along with reasoning. If any sentence is labelled “unsupported”, the answer is considered with hallucination risk.

In this manner, sentences in the answer are checked one by one, and once a sentence is flagged unsupported statement, the answer is considered with hallucination risk. Thus, the answer is fully analyzed to determine whether or not hallucination(s) are present.

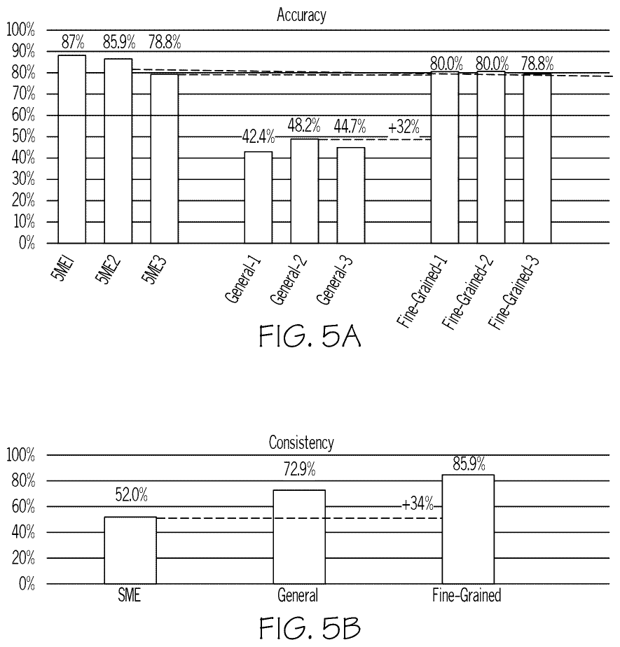

FIG. 5A is a chart that compares sample answer set evaluations performed by human subject-matter experts, the general approach where an LLM is directly asked if a hallucination is present, and the fine-grained hallucination detection method for accuracy illustrated by FIG. 4 based on accuracy. The fine-grained answer sets have almost human-like accuracy and in one case outperforms one human subject-matter answer set. The fine-grained answer sets significantly outperform the human subject-matter experts with respect to consistency.

FIG. 5B is a plot that compares the same sample answer set evaluations as FIG. 5A based on consistency. FIG. 5B shows that the fine-grained hallucination detection method disclosed herein vastly outperforms both the subject-matter experts and the general LLM. Particularly, the fine-grained hallucination detection method outperforms the subject-matter experts with respect to consistency by 34%.

It may be desirable for the rating LLM model to be aligned with human ratings with respect to dimensions such as, without limitation, usefulness, such as relevance, completeness, hallucination, fluency and accuracy. Thus, the auto-rating prompt provided to the LLM model should be fine-tuned to produce answers that are comparable to human attributes with respect to desired dimensions.

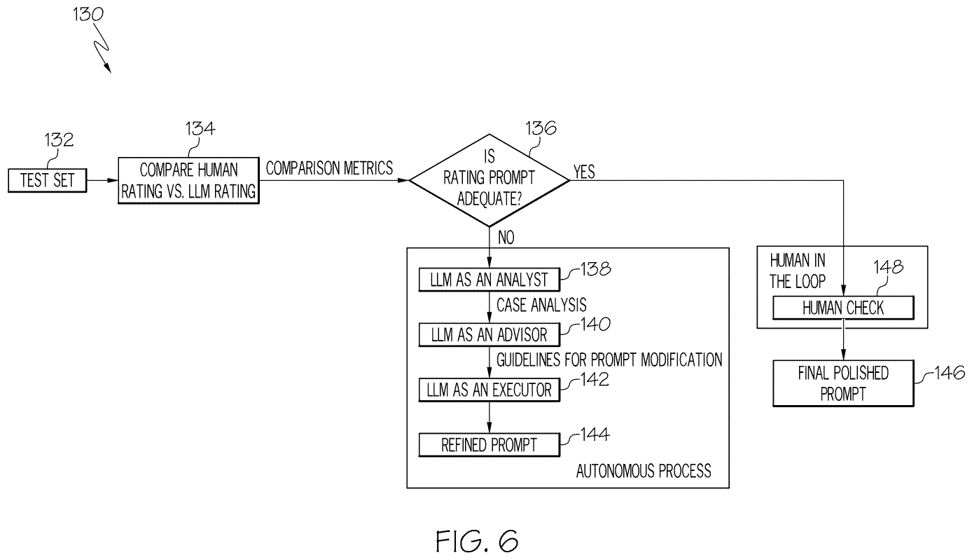

Referring to FIG. 6, a method 130 for refining an auto-rating prompt for the rating LLM model to be aligned with human ratings is illustrated. At block 132, a test set of human ratings and rating LLM model ratings for answers are provided. At block 134, human ratings and the rating LLM model ratings are independently applied to compare two sets of answers generated by two different versions of the product on the same query set. The comparison aims to determine which version of the answers is rated as better over one or more dimensions (e.g., relevance, completeness, etc.). As a non-limiting example, at block 134, the percentage difference in better ratings between the human ratings and the rating LLM model ratings is calculated. For instance, human ratings might determine that Version A is better in 54% of the answers, while the rating LLM model might determine that Version A is better in 46% of the answers, resulting in an 8% difference. If the difference in the percentage of better ratings between the human ratings and the rating LLM model ratings is too large, it may indicate that the auto-rating prompt for the rating LLM model needs to be updated.

The comparison metrics are provided to block 136 where it is determined whether or not the rating prompt of the rating LLM model is adequate, which may be determined by a comparison metric threshold. Using the example above, the comparison metric threshold may be a percent difference threshold, such as, without limitation, 2%. In this example, an 8% difference threshold would not satisfy the comparison metric threshold at block 136 and thus the rating prompt would be considered inadequate.

When the rating prompt is not adequate, the process moves to block 138, which includes an Analyst LLM. The Analyst LLM (block 138) receives the test samples that need to be rated, which are question-and-answer pairs, the rating results from the rating LLM model along with its reasoning, and the human rating results with expert comments. The Analyst LLM is asked to provide information regarding the inconsistency between the human rating and the LLM rating. In other words, the Analyst LLM is asked for the reason for the inconsistency between the human and rating LLM model ratings at block 138. The Analyst LLM outputs a conclusion regarding its reasoning for the inconsistency.

A rating prompt may contain guidelines, instructions, criteria and examples that LLMs can utilize to accomplish an LLM rating task. The actual format and content of a rating prompt varies with the target of the rating task. In method 130, the original rating prompt is included in the inputs of the prompt refinement process (the autonomous process in FIG. 6), and the elements within the original rating prompt are regarded as variables to be modified during the refinement process. The output of the process is an enhanced version of the input rating prompt in terms of accuracy.

The Analyst LLM is an LLM whose operational guidelines are established via a role-defining instruction, aiming to analyze discrepancies between results from the LLM rating and the human expert rating. The inputs to the Analyst LLM may include the query, answer, LLM rating score, LLM rating reasoning, human expert rating score, and human expert rating comments. The Analyst LLM receives instruction to meticulously consider the analysis of the query and answer, compare the LLM rating score with the human expert rating score, and explain any discrepancies, including identifying potential issues in the LLM's evaluation. If the LLM rating result is accurate, the output of Analyst LLM should provide positive feedback, showing no need to adjust the original rating prompt. If not, the output should provide negative feedback, explaining what might be wrong with the rating prompt that leads to differences between the LLM rating and human rating. The output of the Analyst LLM at block 138 includes feedback (positive or negative) with reasoning, detailing if the original rating prompt requires refinement.

At block 140, the output from the Analyst LLM is provided to the Advisor LLM, along with the current version of the LLM rating prompt. By integrating the output from the Analyst LLM and the task-oriented instructions, the Advisor LLM produces specific guidelines and suggestions aimed at improving the rating prompt. These guidelines and suggestions are intended to enhance the accuracy and effectiveness of the LLM rating prompt, thereby reducing the inconsistency between human ratings and those generated by LLM.

The Advisor LLM is an LLM whose operational guidelines are established via a role-defining instruction, aiming to provide guidelines for refining the rating prompt. Example inputs to the Advisor LLM include question, answer, output from the Analyst LLM, and the original rating prompt. Thus, the Advisor LLM receives instruction to provide guidelines aiming at improving the rating prompt based on the feedback from the Analyst LLM. The instructions also provide examples of improvement directions and suggestions as references for the Advisor LLM to provide guidelines for refinement of the rating prompt. The output of the Advisor LLM at block 140 includes guidelines for refining the rating prompt.

The guidelines and suggestions of the Advisor LLM are provided to an Executor LLM at block 142. The Executor LLM is asked to produce a refined rating prompt 144 using not only the guidelines and suggestions of the Advisor LLM, but also modification guidelines that conform to vertical domain constraints. The Executor LLM also receives the current version of the rating prompt that is under evaluation. This refined prompt is then used to generate ratings for answers that are once again compared against human ratings. The process is continued until the comparison metric is satisfied at block 136 and the rating prompt is deemed adequate. Introducing domain adaptation instructions at block 138 and block 140, and introducing domain adaptation constraints at block 142 can further enhance the efficiency of auto-prompt refinement.

The Executor LLM is an LLM whose operational guidelines are established via a role-defining instruction, aiming to accurately refine the rating prompt. The inputs to the Executor LLM may be the output of Advisor LLM and the original rating prompt. The Executor LLM receives instruction to generate the refined rating prompt based on the refinement guidelines provided by the Advisor LLM. The instruction also includes certain implementation of legal domain adaptation constraints, for instance, when revising the examples in the rating prompt, exchange with better ones from a pre-defined golden example list instead of modifying the existing examples. The output of the Executor LLM at block 142 includes the refined rating prompt.

When the rating prompt is deemed adequate at block 136, the process may move to block 148, where a human may verify and select the most promising refined rating prompts based on domain knowledge and produce a final polished rating prompt 146. The final polished rating prompt at block 146 may then be put into production to be used to rate answers.

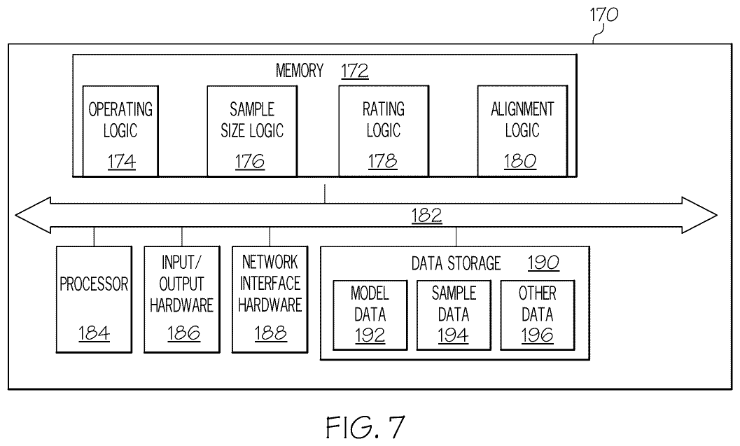

Referring now to FIG. 7, an example computing device 170 for performing the functionalities described herein is schematically illustrated. The example computing device 170 provides a system for evaluating artificial intelligence products, such as question-answer products and other functionalities described herein, and/or a non-transitory computer usable medium having computer readable program code for evaluating artificial intelligence products, such as question-answer products and other functionalities described herein embodied as hardware, software, and/or firmware, according to embodiments shown and described herein. It should be understood that the software, hardware, and/or firmware components depicted in FIG. 7 may also be provided in other computing devices external to the computing device 170 (e.g., data storage devices, remote server computing devices, and the like).

As also illustrated in FIG. 7, the computing device 170 (or other additional computing devices) may include one or more processors 184, input/output hardware 186, network interface hardware 188, and a data storage component 190 (which may store model data 192 for use by one or more large language models described herein, sample data 194 for use by the sample size processes, product rating processes, and human-LLM alignment processes described herein, and any other data 196 for performing the functionalities described herein), and a non-transitory memory component 172. The non-transitory memory component 172 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 172 may be defined by transitory memory and/or signals.

Additionally, the memory component 172 may be configured to store operating logic 174, sample size logic 176 for determining a minimum sample size for evaluation of products, rating logic 178 for finding hallucinations and providing robust pair-wise ratings, and alignment logic 180 for refining a prompt to improve human-LLM alignment (each of which may be embodied as computer readable program code, firmware, or hardware, as an example). It should be understood that the data storage component 190 may reside local to and/or remote from the computing device 170, and may be configured to store one or more pieces of data for access by the computing device 170 and/or other components.

A local interface 182 is also included in FIG. 7 and may be implemented as a bus or other interface to facilitate communication among the components of the computing device 170. The input/output hardware 186 may include an electronic display, a mouse, a touch screen, a microphone, a trackpad, a speaker, a camera, and any other device capable of producing output and receiving input from a user.

The processor 184 may include any processing component configured to receive and execute computer readable code instructions (such as from the data storage component 190 and/or memory component 172). The network interface hardware 188 may include any wired or wireless networking hardware, such as a modem, LAN port, wireless fidelity (Wi-Fi) card, WiMax card, mobile communications hardware, and/or other hardware for communicating with other networks and/or devices.

The components illustrated in FIG. 7 are merely exemplary and are not intended to limit the scope of this disclosure. More specifically, while the components in FIG. 7 are illustrated as residing within the computing device 170, this is a non-limiting example. In some embodiments, one or more of the components may reside external to the computing device 170.

Various example aspects of the present disclosure are described by the enumerated aspect below.

In a first aspect, a method of evaluating a first product and a second product, includes testing a first product to generate a first product score for individual samples of an initial sample size in an initial test, testing a second product to generate a second product score for individual samples of the initial sample size in the initial test, determining an increase rate for first product scores and second product scores for the initial test, determining a confidence level for the first product scores and the second product scores for the initial test, where the confidence level is associated with the increase rate based on a mapping table. The method further includes, when the confidence level is less than a threshold, incrementally increasing a size of the initial sample size, determining an increase rate, and determining an updated confidence level until the confidence level is greater than or equal to the threshold. The method also includes, when the confidence level is greater than or equal to the threshold, selecting the initial sample size as the minimum sample size.

A second aspect according to the first aspect, wherein a y-axis of the mapping table is the sample size and an x-axis of the mapping table is the increase rate.

A third aspect according to the first or second aspect, wherein the initial sample size is within a range of 75 to 125 samples, including endpoints.

A fourth aspect according to any one of the first through third aspects, wherein the first product and the second product are question-answer products incorporating a large language model.

A fifth aspect according to any one of the first through fourth aspects, wherein the confidence level is determined using a t-test.

A sixth aspect according to any one of the first through fifth aspects, wherein a higher increase rate yields a lower sample size for the confidence level to be greater than or equal to the threshold.

A seventh aspect according to any one of the first through sixth aspects, wherein the threshold is 95%.

In an eighth aspect, a method of evaluating a large language model includes receiving a test answer from a test product incorporating a test large language model, receiving a control answer from a control product incorporating a control large language model, and receiving, by an evaluation model, a first evaluation request and a second evaluation request, where each includes the test answer and the control answer, and the test answer is provided prior to the control answer. The method also includes receiving, by the evaluation model, a third evaluation request and a second evaluation request, where each includes the control answer and the test answer, and the control answer is provided prior to the test answer. The method also includes outputting, by the evaluation model, for each of the first evaluation request, the second evaluation request, the third evaluation request, and the fourth evaluation request, a test answer selection when the test answer is a preferred answer, a control answer selection when the control answer is the preferred answer, or a tie when neither the test answer nor the control answer is the preferred answer.

A ninth aspect according to the eighth aspect, wherein the evaluation model is an evaluation large language model.

A tenth aspect according to the eighth or the ninth aspect, wherein the test product is a subsequent version of the control product.

An eleventh aspect according to any one of the eighth through tenth aspects, further comprising selecting the test product as a preferred product when a number of preferred answers for the test answer is greater than a number of preferred answers for the control answer, and selecting the control product as the preferred product when the number of preferred answers for the control answer is greater than the number of preferred answers for the test product.

A twelfth aspect according to any one of the eighth through eleventh aspects, further comprising receiving a plurality of test answers and a plurality of control answers.

In a thirteenth aspect, a method of hallucination prevention for a large language model includes, for each sentence of a document generated by a large language model, outputting, by an evaluation model, the sentence as a conclusion/transition sentence or a non-conclusion/non-transition sentence, when the sentence is a non-conclusion/non-transition sentence, outputting, by the evaluation model, the sentence as directly supported by one or more citations or not directly supported by one or more citations, when the sentence is a non-conclusion/non-transition sentence and is not directly supported by one or more citations, outputting, by the evaluation model, the sentence as indirectly supported by one or more citations or non-indirectly supported by one or more citations, and when the sentence is a non-conclusion/non-transition sentence, is not directly supported by one or more citations, and is not indirectly supported by one or more citations, transmitting a hallucination warning to a user.

A fourteenth aspect according to the thirteenth aspect, wherein when the sentence is directly supported by one or more citations, further outputting, by the evaluation model, the sentence, an index of one or more direct supporting citations, and direct supporting evidence from the one or more direct supporting citations.

A fifteenth aspect according to the thirteenth aspect or the fourteenth aspect, wherein when the sentence is indirectly supported by one or more citations, further outputting, by the evaluation model, the sentence, an index of one or more indirect supporting citations, and indirect supporting content.

A sixteenth aspect according to any one of the thirteenth through fifteenth aspects, wherein the evaluation model is a large language model.

In a seventeenth aspect, a method of automatically generating a prompt for a large language model includes receiving a test set comprising a plurality of human ratings and a plurality of large language model ratings. Each human rating of the plurality of human ratings includes a selection of a first product or a second product, and each large language model rating of the plurality of large language model ratings includes a selection of the first product or the second product using the prompt. The method further includes comparing the plurality of human ratings and the plurality of large language model ratings against a metric. When the metric is satisfied, the method includes transmitting the prompt as a final prompt. When the metric is not satisfied, the method includes generating, by an evaluation large language model, a refined prompt.

An eighteenth aspect according to the seventeenth aspect, wherein generating the refined prompt comprises inputting to an evaluation large language model a plurality of question-answer pairs, the plurality of human ratings, and the plurality of large language model ratings, wherein the plurality of human ratings and the plurality of large language model ratings are based on the plurality of question answer pairs, outputting by the evaluation large language model an inconsistency statement regarding an inconsistency between the plurality of human ratings and the plurality of large language model ratings, inputting to the evaluation large language model, the inconsistency statement and the prompt, outputting by the evaluation large language model one or more suggestions for improving the prompt, inputting to the evaluation large language model the one or more suggestions and the prompt, and outputting by the evaluation large language model the refined prompt.

A nineteenth aspect according to the seventeenth aspect or the eighteenth aspect, further comprising iteratively generating the refined prompt until the refined prompt results in satisfaction of the metric.

A twentieth aspect according to any one of the seventeenth through nineteenth aspects, wherein the metric comprises a threshold percent difference between the plurality of human ratings and the plurality of large language model ratings.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of evaluating a first product and a second product, the method comprising:
testing a first product to generate a first product score for individual samples of an initial sample size in an initial test;
testing a second product to generate a second product score for individual samples of the initial sample size in the initial test;
determining an increase rate for first product scores and second product scores for the initial test;
determining a confidence level for the first product scores and the second product scores for the initial test, wherein the confidence level is associated with the increase rate based on a mapping table;
when the confidence level is less than a threshold, incrementally increasing a size of the initial sample size, determining an increase rate, and determining an updated confidence level until the confidence level is greater than or equal to the threshold; and
when the confidence level is greater than or equal to the threshold, selecting the initial sample size as the minimum sample size.

2. The method of claim 1, wherein a y-axis of the mapping table is the sample size and an x-axis of the mapping table is the increase rate.

3. The method of claim 1, wherein the initial sample size is within a range of 75 to 125 samples, including endpoints.

4. The method of claim 1, wherein the first product and the second product are question-answer products incorporating a large language model.

5. The method of claim 1, wherein the confidence level is determined using a t-test.

6. The method of claim 1, wherein a higher increase rate yields a lower sample size for the confidence level to be greater than or equal to the threshold.

7. The method of claim 1, wherein the threshold is 95%.

8. A method of evaluating a large language model, the method comprising:
receiving a test answer from a test product comprising a test large language model;
receiving a control answer from a control product comprising a control large language model;
receiving, by an evaluation model, a first evaluation request and a second evaluation request each comprising the test answer and the control answer, wherein the test answer is provided prior to the control answer;
receiving, by the evaluation model, a third evaluation request and a second evaluation request each comprising the control answer and the test answer, wherein the control answer is provided prior to the test answer;
outputting, by the evaluation model, for each of the first evaluation request, the second evaluation request, the third evaluation request, and the fourth evaluation request, a test answer selection when the test answer is a preferred answer, a control answer selection when the control answer is the preferred answer, or a tie when neither the test answer nor the control answer is the preferred answer.

9. The method of claim 8, wherein the evaluation model is an evaluation large language model.

10. The method of claim 8, wherein the test product is a subsequent version of the control product.

11. The method of claim 8, further comprising selecting the test product as a preferred product when a number of preferred answers for the test answer is greater than a number of preferred answers for the control answer, and selecting the control product as the preferred product when the number of preferred answers for the control answer is greater than the number of preferred answers for the test product.

12. The method of claim 8, further comprising receiving a plurality of test answers and a plurality of control answers.

13. A method of hallucination prevention for a large language model, the method comprising, for each sentence of a document generated by a large language model:
outputting, by an evaluation model, the sentence as a conclusion/transition sentence or a non-conclusion/non-transition sentence;
when the sentence is a non-conclusion/non-transition sentence, outputting, by the evaluation model, the sentence as directly supported by one or more citations or not directly supported by one or more citations;
when the sentence is a non-conclusion/non-transition sentence and is not directly supported by one or more citations, outputting, by the evaluation model, the sentence as indirectly supported by one or more citations or non-indirectly supported by one or more citations; and
when the sentence is a non-conclusion/non-transition sentence, is not directly supported by one or more citations, and is not indirectly supported by one or more citations, transmitting a hallucination warning to a user.

14. The method of claim 13, wherein when the sentence is directly supported by one or more citations, further outputting, by the evaluation model, the sentence, an index of one or more direct supporting citations, and direct supporting evidence from the one or more direct supporting citations.

15. The method of claim 13, wherein when the sentence is indirectly supported by one or more citations, further outputting, by the evaluation model, the sentence, an index of one or more indirect supporting citations, and indirect supporting content.

16. The method of claim 13, wherein the evaluation model is a large language model.

17. A method of automatically generating a prompt for a large language model, the method comprising:
receiving a test set comprising a plurality of human ratings and a plurality of large language model ratings, wherein:
each human rating of the plurality of human ratings comprises a selection of a first product or a second product;
each large language model rating of the plurality of large language model ratings comprises a selection of the first product or the second product using the prompt;
comparing the plurality of human ratings and the plurality of large language model ratings against a metric;
when the metric is satisfied, transmitting the prompt as a final prompt;
when the metric is not satisfied, generating, by an evaluation large language model, a refined prompt.

18. The method of claim 17, wherein generating the refined prompt comprises:
inputting to an evaluation large language model a plurality of question-answer pairs, the plurality of human ratings, and the plurality of large language model ratings, wherein the plurality of human ratings and the plurality of large language model ratings are based on the plurality of question answer pairs;
outputting by the evaluation large language model an inconsistency statement regarding an inconsistency between the plurality of human ratings and the plurality of large language model ratings;
inputting to the evaluation large language model, the inconsistency statement and the prompt;
outputting by the evaluation large language model one or more suggestions for improving the prompt;
inputting to the evaluation large language model the one or more suggestions and the prompt; and
outputting by the evaluation large language model the refined prompt.

19. The method of claim 17, further comprising iteratively generating the refined prompt until the refined prompt results in satisfaction of the metric.

20. The method of claim 17, wherein the metric comprises a threshold percent difference between the plurality of human ratings and the plurality of large language model ratings.
